(19) United States
(12) Patent Application Publication
(10) Pub. No.: US 2025/0330801 A1
(43) Pub. Date: Oct. 23, 2025

(54) SYSTEMS, METHODS, AND DEVICES FOR WIRELESS DEVICE PROVISIONING

(71) Applicant: Cypress Semiconductor Corporation, San Jose, CA (US)

(72) Inventors: Yashas Nanjungud Suryanarayana Iyer, Bengaluru (IN); Jayakumar Thiruppathi, Thirunagar (IN); Aadhi Vairava Sundaram Kathalingam, Mountain View, CA (US)

(73) Assignee: Cypress Semiconductor Corporation, San Jose, CA (US)

(21) Appl. No.: 18/639,494

(22) Filed: Apr. 18, 2024

(51) Int. Cl. H04W 8/20; H04W 64/00

(52) U.S. Cl. CPC H04W 8/205; H04W 64/00

(57) ABSTRACT

Systems, methods, and devices provide device provisioning of wireless devices in wireless environments. Methods include determining, at a central wireless device, angle of arrival information associated with a first transceiver of the central wireless device and a first wireless connection with a peripheral wireless device, generating wireless profile data for a second wireless connection with the peripheral wireless device, and transmitting the wireless profile data via the first wireless connection to the peripheral wireless device to configure the second wireless connection of the peripheral wireless device.

### TECHNICAL FIELD

This disclosure relates to wireless devices, and more specifically, to efficient provisioning of such wireless devices in wireless environments.

### BACKGROUND

Wireless devices may communicate with each other via a communications network via one or more wireless communications protocols, such as a Wi-Fi protocol. Such wireless devices may have various different capabilities ranging from access points to Internet-of-Things (IoT) devices. Moreover, such wireless devices may have associated profiles used to configure levels of access granted to such wireless devices as well as authorization of network accesses by such wireless devices. Conventional techniques for managing such profiles remain limited because they use queries to back-end servers and additional network resources for such management.

### BRIEF DESCRIPTION OF THE DRAWINGS

FIG. 1 illustrates an example of a system for wireless device provisioning, configured in accordance with some embodiments.

FIG. 2 illustrates an example of a device for wireless devices provisioning, configured in accordance with some embodiments.

FIG. 3 illustrates an example of a method for wireless device provisioning, performed in accordance with some embodiments.

FIG. 4 illustrates another example of a method for wireless device provisioning, performed in accordance with some embodiments.

FIG. 5 illustrates an additional example of a method for wireless device provisioning, performed in accordance with some embodiments.

FIG. 6 illustrates another example of a method for wireless device provisioning, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices operating in a wireless environment may communicate via a wireless network. Such wireless devices may have levels of access and authorization as may be established by a device provisioning scheme. Accordingly, device provisioning may be implemented to define authorization and access parameters for each wireless device on the wireless network. Accordingly, such device provisioning schemes may define authentication techniques and access levels for each wireless device on the wireless network. In one example, a device provisioning scheme may assign a first level of access to “guest” devices, and a second level of access to “administrator” where the second level of access has a higher level of access to network components. Moreover, such device provisioning schemes may also be used to authorize and manage network events, such as network accesses and connection events associated with such wireless devices. In various embodiments, device provisioning may be used in processes such as device setup and configuration operations, as may occur when making a device, such as a smart phone or a smart TV available on a network.

Conventional techniques for device provisioning often store such device provisioning schemes at a back-end server and use such a back-end server to manage such information for each device. Accordingly, storage and retrieval of such information includes server queries to a server that may be implemented in a different network and/or in a cloud environment. Moreover, updating, management, and configuration of such device provisioning information at each device also includes such server queries. Accordingly, conventional techniques remain limited because they use additional network resources and back-end servers to manage such device provisioning operations.

Embodiments disclosed herein provide device provisioning that may be managed by a wireless device that may be implemented within the wireless network. As will be discussed in greater detail below, a central device may be configured to store and manage device provisioning information for various wireless devices connected to the wireless network. Moreover, the central device may leverage a second communications modality to facilitate profile configuration of such wireless devices. For example, an access point on a Wi-Fi network may utilize an ultrawideband (UWB) communications channel to configure profile information associated with device provisioning for various wireless devices of the wireless network. When configured in this way, the central device may manage the device provisioning scheme locally, and communications with remote servers are not used for such purposes.

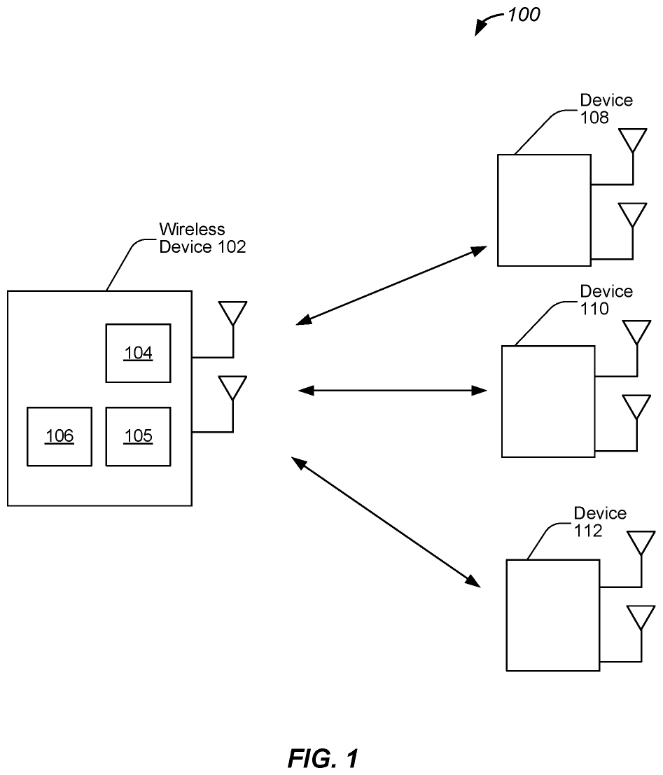

FIG. 1 illustrates an example of a system for wireless device provisioning, configured in accordance with some embodiments. Accordingly, a system, such as system 100, may include wireless devices that are used for wireless communications, and are also configured to be able to perform wireless device provisioning operations. Accordingly, as will be discussed in greater detail below, wireless devices included in system 100 may be configured to perform device provisioning without the use of an additional back-end architecture, thus enabling profile information of such wireless devices to be managed more efficiently and with less network resource overhead.

In some embodiments, system 100 includes wireless device 102 which is configured to transmit and receive wireless signals in accordance with one or more communications protocols. For example, wireless device 102 may include one or more transceivers, such as transceiver 104 and transceiver 105, which are configured to transmit and receive signals in accordance with a wireless communications protocol, such as a Wi-Fi protocol, a UWB protocol, or any other suitable protocol. In various embodiments, wireless device 102 additionally includes a processing device, such as processing device 106, which is configured to implement various hardware and logic associated with transceiver 104 and transceiver 105, and their associated wireless communications protocols. For example, processing device 106 may be configured to implement a medium access control (MAC) layer that is configured to control hardware associated with a wireless transmission medium, such as that associated with a Wi-Fi transmission medium. Processing device 106 may additionally be configured to implement various services and modules included in the UWB stack, as may be defined by a UWB standard and specification. As will be discussed in greater detail below, wireless device 102 may be configured such that transceiver 104 is a Wi-Fi transceiver and transceiver 105 is a UWB transceiver.

In various embodiments, wireless device 102 is within communications range of one or more devices or entities. In one example, wireless device 102 is within range of device 108, which may be another wireless device. Accordingly, device 108 may also include transceivers and associated processing logic configured to facilitate wireless communications in accordance with a wireless communications protocol, such as a Wi-Fi protocol and/or a UWB protocol. Thus, wireless device 102 may be configured to establish a wireless connection with device 108, and transmit and receive data packets from device 108.

Moreover, in some embodiments, wireless device 102 is configured as a central device, and device 108 is configured as a peripheral device. For example, wireless device 102 is configured as an access point, and device 108 is configured as a station. In one example, device 108 may be a peripheral device, such as a printer or some other IoT device included in a wireless environment. In this example, wireless device 102 may be configured as an access point that manages profile information for such peripheral devices via various device provisioning operations. As disclosed herein, profile information may include wireless profile data for each associated peripheral device.

As shown in FIG. 1, wireless device 102 may also be communicatively coupled to additional devices, such as device 110 and device 112. In various embodiments, device 110 and device 112 may also include transceivers and associated processing logic configured to facilitate wireless communications in accordance with a wireless communications protocol, such as a Wi-Fi protocol and/or a UWB protocol. Accordingly, wireless device 102 may be in communication with multiple peripheral devices included in a wireless environment, and may be used to manage wireless profile information for multiple peripheral devices via device provisioning operations within that wireless environment.

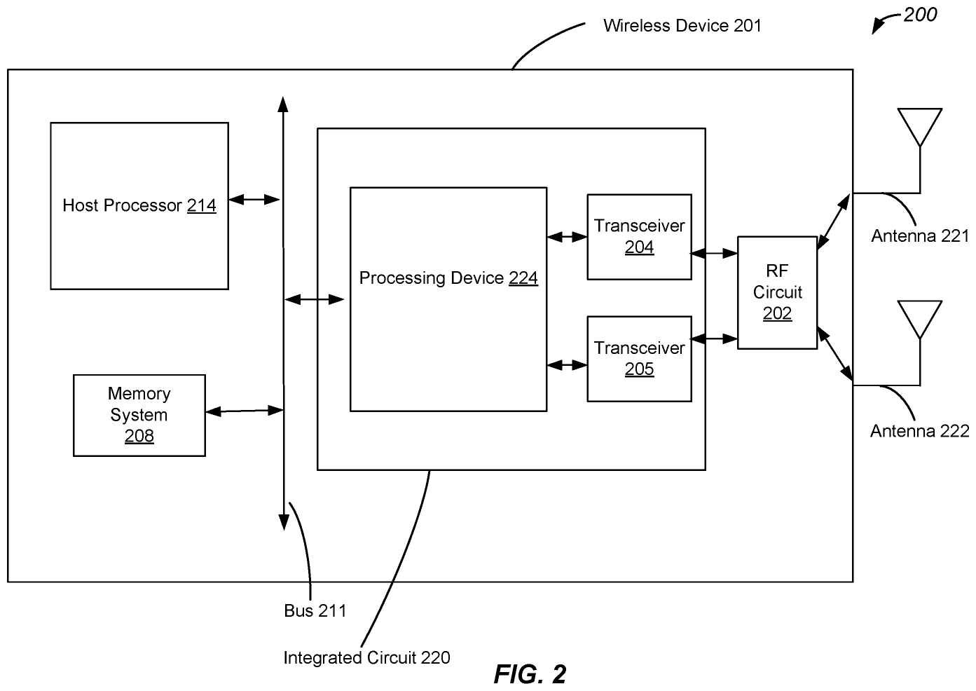

FIG. 2 illustrates an example of a device for wireless devices provisioning, configured in accordance with some embodiments. As similarly discussed above, a system, such as system 200, may include wireless devices that are used for wireless communications, and are also configured to be able to perform wireless device provisioning operations. Accordingly, as will be discussed in greater detail below, wireless devices included in system 200 may be configured to perform device provisioning without the use of an additional back-end architecture, thus enabling profile information of such wireless devices to be managed more efficiently and with less network resource overhead. It will be appreciated that wireless device 201 may be one of the wireless devices discussed above with reference to FIG. 1, such as wireless device 102.

In various embodiments, wireless device 201 includes one or more transceivers, such as transceiver 204 and transceiver 205. In one example, system 200 includes transceiver 204 which is configured to transmit and receive signals using a communications medium that may include antenna 221 or antenna 222. As noted above, transceiver 204 may be a Wi-Fi transceiver. Accordingly, transceiver 204 may be compatible with a Wi-Fi communications protocol. For example, the Wi-Fi communications protocol may be an 802.11ax protocol, an 802.11be protocol, an 802.11bn protocol, or any other suitable version of Wi-Fi. In various embodiments, transceiver 204 includes a modulator and demodulator as well as one or more buffers and filters, that are configured to generate and receive signals via antenna 221 and/or antenna 222.

System 200 additionally includes transceiver 205 which may be collocated with transceiver 204 in wireless device 201. In various embodiments, transceiver 205 is also be configured to transmit and receive signals using a communications medium that may include antenna 221 or antenna 222. In various embodiments, transceiver 205 may be a UWB transceiver compatible with a UWB communications protocol. Moreover, transceiver 205 includes a modulator and demodulator as well as one or more buffers and filters, that are configured to generate and receive signals via antenna 221 and/or antenna 222. While various embodiments are described with reference to a Wi-Fi and UWB communications protocols, it will be appreciated that any suitable protocols may be used.

In various embodiments, system 200 further includes one or more processing devices, such as processing device 224 which may include logic implemented using one or more processor cores. Accordingly, processing device 224 is configured to implement logic for wireless device provisioning operations, as will be discussed in greater detail below. For example, processing device 224 may be configured to manage associations between angle of arrival information and wireless device profile information for the purposes of wireless device provisioning. In various embodiments, such angle of arrival information may include phase difference measurements and/or time difference measurements made by antennas within an antenna array. Such antennas, such as antenna 221 and antenna 222 discussed in greater detail below, may be included in an antenna array configured for such angle of arrival measurements. Moreover, as will be discussed in greater detail below, angle of arrival information may be obtained via a first communications protocol, and used for provisioning of profiles of another communications protocol. For example, angle of arrival information may be obtained via UWB communications, and used to manage Wi-Fi profile data, as may occur during device provisioning. Accordingly, processing device 224 includes processing elements configured to perform the wireless device provisioning operations that will be described in greater detail below.

Processing device 224 includes one or more components configured to implement a media access control (MAC) layer that is configured to control hardware associated with a wireless transmission medium, such as that associated with a Wi-Fi transmission medium. In one example, processing device 224 may be configured to implement a driver, such as a Wi-Fi driver. Accordingly, processing device 224 may include components associated with transceiver 204, such as MAC layers, packet traffic arbiters, and a scheduler. In various embodiments, processing device 224 may further include various services and modules included in the UWB stack, as may be defined by a UWB standard and specification.

System 200 further includes radio frequency (RF) circuit 202 which is coupled to antenna 221 and antenna 222. In various embodiments, RF circuit 202 may include various components such as an RF switch, a diplexer, and a filter. Accordingly, RF circuit 202 may be configured to select an antenna for transmission/reception, and may be configured to provide coupling between the selected antenna, such as antenna 221 or antenna 222, and other components of system 200 via a bus, such as bus 211. While one RF circuit is shown, it will be appreciated that wireless device 201 may include multiple RF circuits. Accordingly, each of multiple antennas may have its own RF circuit, or they may share RF circuits.

System 200 includes memory system 208 which is configured to store one or more data values associated with wireless device provisioning operations discussed in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204, transceiver 205, and processing device 224 may be implemented on the same integrated circuit chip, such as integrated circuit chip 220. In another example transceiver 204, transceiver 205, and processing device 224 may each be implemented on their own chip, and thus may be disposed separately as a multi-chip module or on a common substrate such as a printed circuit board (PCB). Accordingly, transceiver 204, transceiver 205, and processing device 224 may implemented on the same silicon substrate, or may each be implemented on different silicon substrates that may be implemented in a single package of a multi-chip module. It will also be appreciated that components of system 200 may be implemented in the context of an IoT environment and/or a smart home environment. Accordingly, wireless devices disclosed herein may be implemented in the context of a smart home enabled device, an IoT device, or any wireless device in communication with such devices.

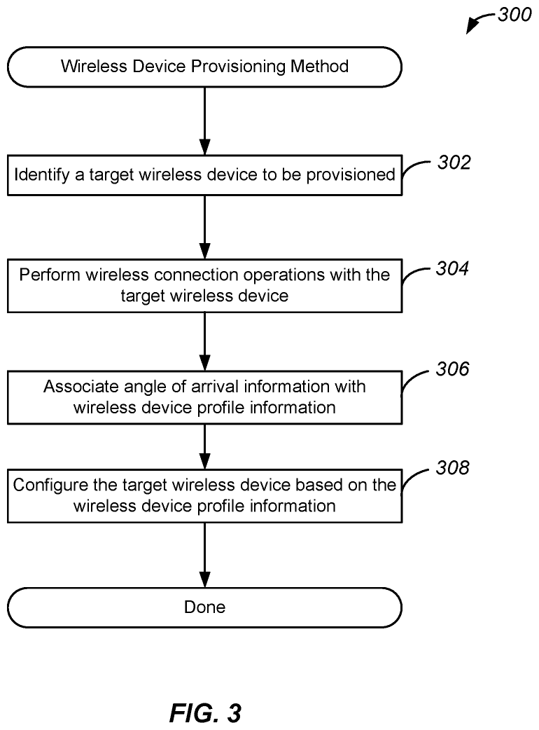

FIG. 3 illustrates an example of a method for wireless device provisioning, performed in accordance with some embodiments. Accordingly, a method, such as method 300, may be performed to manage associations between wireless devices and wireless device profiles thus implementing wireless device provisioning without the use of an additional back-end architecture.

Method 300 may perform operation 302 during which a target wireless device to be provisioned may be identified. In various embodiments, the target wireless device may be a peripheral wireless device that is identified at a central wireless device. In some embodiments, the target wireless device may be identified by an entity, such as a user or administrator. Moreover, the identifying may occur responsive to one or more actions taken by the entity, such as a change in position or orientation of the central wireless device. In one example, the entity may point the central wireless device at the peripheral wireless device thus manually orienting the direction of one or more antennas of the central wireless device towards the peripheral wireless device. In various embodiments, identifying of the target wireless device may be performed via retrieval of one or more identifiers, such as a device identifier.

Method 300 may perform operation 304 during which wireless connection operations may be performed with the target wireless device. Accordingly, the central wireless device may establish a communications link with the peripheral wireless device and perform wireless connection operations in accordance with a wireless communications protocol, such as a UWB protocol. Thus, during operation 304 connection establishment and negotiation operations may be performed.

Method 300 may perform operation 306 during which angle of arrival information may be associated with wireless device profile information. In various embodiments, the angle of arrival information may have been determined as part of the connection establishment operations using the UWB transceiver and protocol. Accordingly, the angle of arrival information may have been stored during operation 304 based on UWB communications, and during operation 306, the angle of arrival information may be retrieved.

Wireless device profile information may also be stored and managed by the central device. Such wireless device profile information may include wireless profile data such as security profile information that defines permissible access levels of the peripheral device on the communications network. Moreover, such wireless profile data may include profile information for a different wireless connection, such as a Wi-Fi connection. Accordingly, during operation 306 an angle of arrival determined for the peripheral device based on a UWB communications link may be mapped to Wi-Fi profile information for the same peripheral device.

In various embodiments, such angle of arrival information may include phase difference measurements and/or time difference measurements. As similarly discussed above, differences in measurements made by different antennas in an antenna array may be used to infer an estimated angle of arrival of a signal based on phase differences between measurements by different antennas and/or time of arrival differences between measurements by different antennas. It will be appreciated that any suitable computation technique for computing angle of arrival information may be used on such difference measurements to generate angles of arrival. Moreover, in some embodiments no mapping is used, and angle of arrival information may be monitored and used independently.

Method 300 may perform operation 308 during which the target wireless device may be configured based on the wireless device profile information. Accordingly, current Wi-Fi profile information may be transmitted to the peripheral device, and the peripheral device may configure its Wi-Fi connection based on the received wireless device profile information. Moreover, such transmission and configuration may be dependent upon the angle of arrival information. As will be discussed in greater detail below, such transmission and configuration may be allowed so long as the angle of arrival information is within a designated threshold of an initial value.

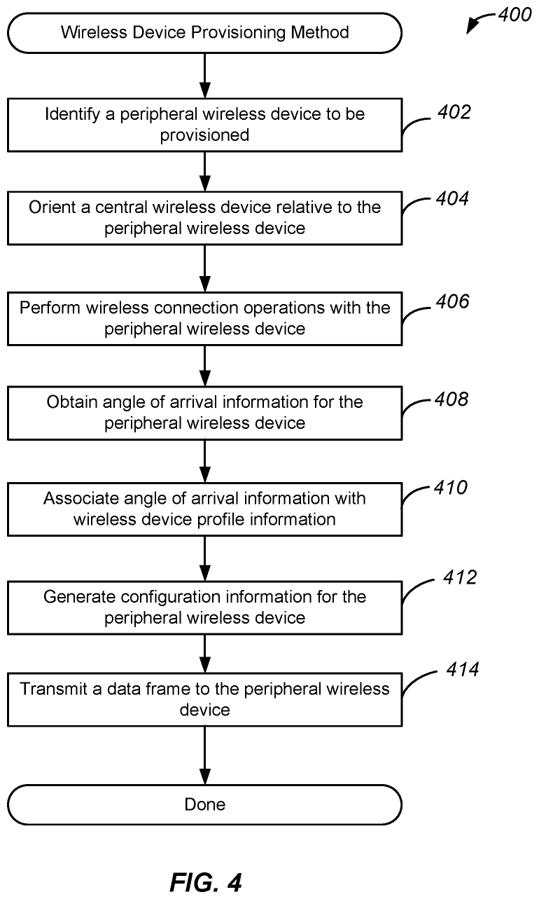

FIG. 4 illustrates another example of a method for wireless device provisioning, performed in accordance with some embodiments. Accordingly, a method, such as method 400, may be performed to manage associations between wireless devices and wireless device profiles thus implementing wireless device provisioning without the use of an additional back-end architecture. As will be discussed in greater detail below, communications via two different wireless connections and corresponding protocols may be leveraged to perform such device provisioning.

Method 400 may perform operation 402 during which a peripheral wireless device to be provisioned may be identified. As similarly discussed above, the target wireless device may be a peripheral wireless device that is identified at a central wireless device. In one example, the central wireless device may be configured as an access point, and the peripheral device may be configured as a station. In some embodiments, the target wireless device may be identified by an entity, such as a user or administrator. In one example, the wireless device may be identified in response to one or more communications events, such as a disconnection of a wireless connection between the central wireless device and the peripheral wireless device.

Method 400 may perform operation 404 during which a central wireless device may be oriented relative to the peripheral wireless device. Accordingly, as similarly discussed above, the entity may be a user that points the central wireless device at the peripheral wireless device thus orienting the central wireless device towards the peripheral wireless device. As similarly discussed above, orientation of the central wireless device may include physically adjusting a spatial orientation of the central wireless device by a user or an automated rotational mount. In one example, a UWB transceiver of the central wireless device is oriented towards the peripheral device during operation 404. In another example, the central wireless device is a mobile device that is freely movable.

Method 400 may perform operation 406 during which wireless connection operations may be performed with the peripheral wireless device. Accordingly, the central wireless device may establish a communications link with the peripheral wireless device and perform wireless connection operations in accordance with a wireless communications protocol, such as a UWB protocol. Thus, during operation 406 connection establishment, negotiation, and authentication operations may be performed for the central wireless device and the peripheral wireless device.

Method 400 may perform operation 408 during which angle of arrival information may be obtained for the peripheral wireless device. As similarly discussed above, the angle of arrival information may have been determined as part of the connection establishment operations using the UWB transceiver and protocol. Such angle of arrival information may include an estimated angle of arrival of a signal received from the peripheral wireless device, and may also include underlying phase and/or time difference measurements from different antennas in an antenna array of the central wireless device. Accordingly, angle of arrival information may have been determined during operation 406 in accordance with a UWB communications protocol, and during operation 408, such angle of arrival information may be retrieved.

Method 400 may perform operation 410 during which angle of arrival information may be associated with wireless device profile information. As similarly discussed above, wireless device profile information may also be stored and managed by the central device. Such wireless device profile information may include security profile information that defines permissible access levels of the peripheral device on the communications network for, for example, Wi-Fi communications. Accordingly, such wireless device profile information is profile information for a wireless connection of a collocated transceiver and its associated connection, which may be a Wi-Fi connection. Thus, during operation 410, the central wireless device may generate and/or update a data object that includes a wireless device provisioning mapping. More specifically, the angle of arrival information determined based on the UWB communications may be mapped to Wi-Fi profile information for the same peripheral device. It will be appreciated that the mapping may store additional data values as well, such as a device identifier associated with the peripheral wireless device.

Method 400 may perform operation 412 during which configuration information may be generated for the peripheral wireless device. In various embodiments, the configuration information includes a data object that is configured to include Wi-Fi profile information that will be sent to the peripheral wireless device. Such configuration information may be determined based on permission parameters or other security parameters that may be determined by an entity, such as a user or administrator. Accordingly, configuration information may be generated, at least in part, based on designated configuration parameters set by an administrator or a user.

Method 400 may perform operation 414 during which a data frame may be transmitted to the peripheral wireless device. As similarly discussed above, current Wi-Fi profile information may be transmitted to the peripheral wireless device, and the peripheral wireless device may configure its Wi-Fi connection based on the received wireless device profile information. In some embodiments, the profile information is included in a UWB data frame, and the UWB data frame is transmitted from the central wireless device to the peripheral wireless device. In one example, the Wi-Fi profile information is included as an XML payload within the UWB data frame. It will be appreciated that the peripheral wireless device is configured to receive the UWB data frame, extract the contents of the payload, and update its profile information based on the extracted contents.

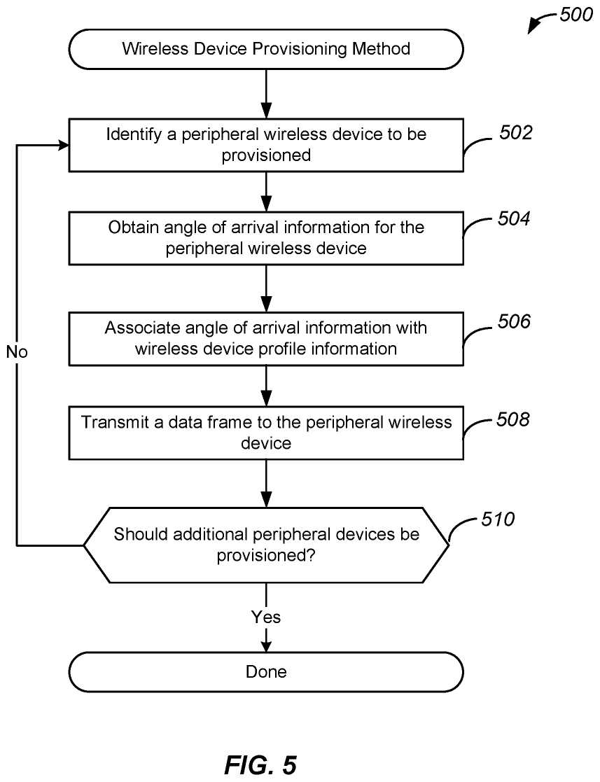

FIG. 5 illustrates an additional example of a method for wireless device provisioning, performed in accordance with some embodiments. Accordingly, a method, such as method 500, may be performed to manage associations between wireless devices and wireless device profiles thus implementing wireless device provisioning without the use of an additional back-end architecture. As will be discussed in greater detail below, device provisioning may be performed iteratively and for multiple wireless devices. In this way, embodiments disclosed herein may provide wireless device provisioning for multiple wireless devices implemented in a wireless environment.

Method 500 may perform operation 502 during which a peripheral wireless device to be provisioned may be identified. As similarly discussed above, the target wireless device may be a peripheral wireless device that is identified at a central wireless device. In one example, the central wireless device may be configured as an access point, and the peripheral device may be configured as a station. In some embodiments, the target wireless device may be identified by an entity, such as a user or administrator.

In one example, the entity may point the central wireless device at the peripheral wireless device thus orienting the central wireless device towards the peripheral wireless device. Accordingly, the central wireless device may establish a communications link with the peripheral wireless device and perform wireless connection operations in accordance with a wireless communications protocol, such as a UWB protocol.

Method 500 may perform operation 504 during which angle of arrival information may be obtained for the peripheral wireless device. As similarly discussed above, such angle of arrival information may include an estimated angle of arrival of a signal received from the peripheral wireless device, and may also include underlying phase and/or time difference measurements from different antennas in an antenna array of the central wireless device. In various embodiments, the angle of arrival information may have been determined as part of the connection establishment operations using the UWB transceiver and protocol.

Method 500 may perform operation 506 during which the angle of arrival information may be associated with wireless device profile information. As similarly discussed above, angle of arrival information may have been determined as part of the connection establishment operations using the UWB transceiver and protocol. Moreover, wireless device profile information may also be stored and managed by the central device. Accordingly, during operation 506, the central wireless device may generate and/or update a data object that includes a wireless device provisioning mapping. More specifically, the angle of arrival information determined based on the UWB communications may be mapped to Wi-Fi profile information for the same peripheral device. It will be appreciated that the mapping may store additional data values as well, such as a device identifier associated with the peripheral wireless device.

Method 500 may perform operation 508 during which a data frame may be transmitted to the peripheral wireless device. Accordingly, current Wi-Fi profile information may be transmitted to the peripheral device, and the peripheral device may configure its Wi-Fi connection based on the received wireless device profile information. As similarly discussed above, the profile information is included in a UWB data frame, and the UWB data frame is transmitted from the central wireless device to the peripheral wireless device. In one example, the Wi-Fi profile information is included as an XML payload within the UWB data frame.

Method 500 may perform operation 510 during which it may be determined if additional peripheral devices be provisioned. Such a determination may be made based on wireless device information stored and maintained by the central wireless device and/or an entity, such as a user or administrator. Accordingly, a list of discovered network devices may be stored as wireless device information, and method 500 may sequentially progress through the wireless devices included in the list. In various embodiments, such wireless devices may be identified based on one or more configuration parameters, such as version data of firmware or other configuration information. If it is determined that additional peripheral devices should be provisioned, method 500 may return to operation 502. If it is determined that additional wireless devices should not be provisioned, method 500 may terminate.

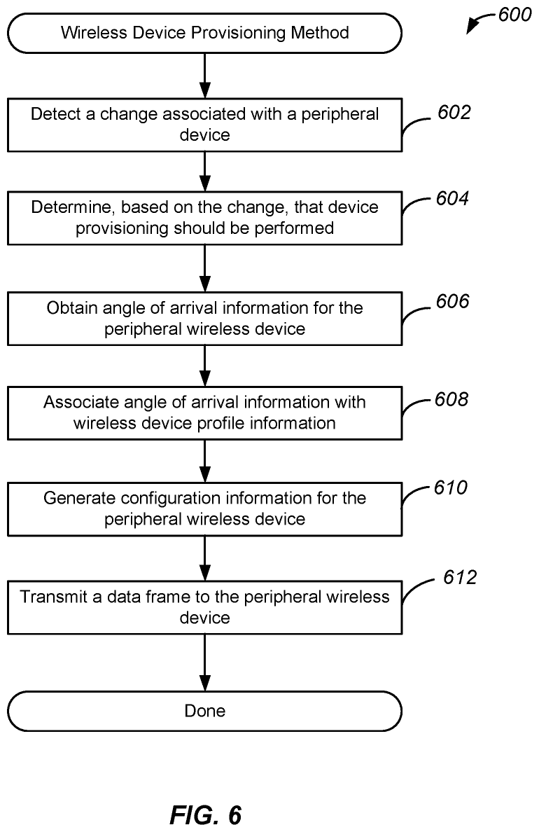

FIG. 6 illustrates another example of a method for wireless device provisioning, performed in accordance with some embodiments. Accordingly, a method, such as method 600, may be performed to manage associations between wireless devices and wireless device profiles to implement wireless device provisioning. As will be discussed in greater detail below, device provisioning may be performed in response to one or more conditions or events within a wireless environment.

Method 600 may perform operation 602 during which a change associated with a peripheral device may be detected. As similarly discussed above, the change may be a change in one or more wireless connection parameters or a network status of the peripheral device. For example, the change may be a loss of connectivity with a central wireless device due to the peripheral wireless device moving outside of Wi-Fi range of the central wireless device. In some embodiments, the change may be some other system or device event, such as a loss of power, a network fault, packet error or corruption, or other unexpected network disconnection.

Method 600 may perform operation 604 during which it may be determined, based on the change, that device provisioning should be performed. In one example, the central device may be configured to detect that the change has occurred, and may be configured to determine that one or more device provisioning operations should be performed once connectivity is reestablished with the peripheral wireless device.

Method 600 may perform operation 606 during which angle of arrival information may be obtained for the peripheral wireless device. As similarly discussed above, the central wireless device may establish a communications link with the peripheral wireless device and perform wireless connection operations in accordance with a wireless communications protocol, such as a UWB protocol. Moreover, angle of arrival information may have been determined as part of the connection establishment operations using the UWB transceiver and protocol. As also discussed above, such angle of arrival information may include an estimated angle of arrival of a signal received from the peripheral wireless device, and may also include underlying phase and/or time difference measurements made based on measurements made by different antennas in an antenna array of the central wireless device.

Method 600 may perform operation 608 during which angle of arrival information may be associated with wireless device profile information. As similarly discussed above, angle of arrival information may have been determined as part of the connection establishment operations using the UWB transceiver and protocol. Moreover, wireless device profile information may also be stored and managed by the central device. Accordingly, during operation 608, the central wireless device may generate and/or update a data object that includes a wireless device provisioning mapping. More specifically, the angle of arrival information determined based on the UWB communications may be mapped to Wi-Fi profile information for the same peripheral device. It will be appreciated that the mapping may store additional data values as well, such as a device identifier associated with the peripheral wireless device.

Method 600 may perform operation 610 during which configuration information may be generated for the peripheral wireless device. In various embodiments, the configuration information includes a data object that is configured to include Wi-Fi profile information that will be sent to the peripheral wireless device. Such configuration information may be determined based on permission parameters or other security parameters that may be determined by an entity, such as a user or administrator.

Method 600 may perform operation 612 during which a data frame may be transmitted to the peripheral wireless device. Accordingly, current Wi-Fi profile information may be transmitted to the peripheral device, and the peripheral device may configure its Wi-Fi connection based on the received wireless device profile information. As similarly discussed above, the profile information is included in a UWB data frame, and the UWB data frame is transmitted from the central wireless device to the peripheral wireless device. In one example, the Wi-Fi profile information is included as an XML payload within the UWB data frame.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining, at a central wireless device, angle of arrival information associated with a first transceiver of the central wireless device and a first wireless connection with a peripheral wireless device;
generating wireless profile data for a second wireless connection with the peripheral wireless device; and
transmitting the wireless profile data via the first wireless connection to the peripheral wireless device to configure the second wireless connection of the peripheral wireless device.

2. The method of claim 1, wherein the first wireless connection is an ultrawideband (UWB) connection and the second wireless connection is a Wi-Fi connection.

3. The method of claim 1, wherein the angle of arrival information is determined based on a signal received from the peripheral wireless device at the central wireless device.

4. The method of claim 1 further comprising:
mapping the angle of arrival information to a wireless profile of the peripheral wireless device.

5. The method of claim 1, wherein the angle of arrival information comprises phase difference information or time difference information obtained via an antenna array of the central wireless device.

6. The method of claim 1, wherein the wireless profile data comprises authentication information for the peripheral wireless device on the second wireless connection.

7. The method of claim 1, wherein the wireless profile data is transmitted via a data frame of the first wireless connection.

8. The method of claim 7, wherein the wireless profile data comprises Wi-Fi profile data, wherein the Wi-Fi profile data is included in a payload of the data frame, and wherein the data frame is a UWB data frame.

9. The method of claim 1, wherein the central wireless device is an access point, and wherein the peripheral wireless device is a station.

10. A system comprising:
a first transceiver configured to be compatible with a first wireless communications protocol;
a second transceiver configured to be compatible with a second wireless communications protocol, wherein the second transceiver is collocated with the first transceiver in a central wireless device;
a processing device configured to:
determine angle of arrival information associated with the first transceiver of the central wireless device and a first wireless connection with a peripheral wireless device;
generate wireless profile data for a second wireless connection with the peripheral wireless device; and
transmit the wireless profile data via the first wireless connection to the peripheral wireless device to configure the second wireless connection of the peripheral wireless device.

11. The system of claim 10, wherein the first wireless connection is an ultrawideband (UWB) connection and the second wireless connection is a Wi-Fi connection.

12. The system of claim 10, wherein the angle of arrival information is determined based on a signal received from the peripheral wireless device at the central wireless device.

13. The system of claim 10, wherein the processing device is further configured to:
map the angle of arrival information to a wireless profile of the peripheral wireless device.

14. The system of claim 10, wherein the wireless profile data comprises authentication information for the peripheral wireless device on the second wireless connection.

15. The system of claim 10, wherein the wireless profile data is transmitted via a UWB data frame of the first wireless connection, wherein the wireless profile data comprises Wi-Fi profile data, wherein the Wi-Fi profile data is included in a payload of the UWB data frame.

16. A device comprising:
processing elements included in a central wireless device configured to:
determine angle of arrival information associated with a first transceiver of the central wireless device and a first wireless connection with a peripheral wireless device;
generate wireless profile data for a second wireless connection with the peripheral wireless device; and
transmit the wireless profile data via the first wireless connection to the peripheral wireless device to configure the second wireless connection of the peripheral wireless device.

17. The device of claim 16, wherein the first wireless connection is an ultrawideband (UWB) connection and the second wireless connection is a Wi-Fi connection.

18. The device of claim 16, wherein the angle of arrival information is determined based on a signal received from the peripheral wireless device at the central wireless device.

19. The device of claim 16, wherein the processing elements are further configured to:
map the angle of arrival information to a wireless profile of the peripheral wireless device.

20. The device of claim 16, wherein the wireless profile data is transmitted via a UWB data frame of the first wireless connection, wherein the wireless profile data comprises Wi-Fi profile data, wherein the Wi-Fi profile data is included in a payload of the UWB data frame.
